(19) United States
(12) Patent Application Publication
(10) Pub. No.: US 2011/0290916 A1
(43) Pub. Date: Dec. 1, 2011

(54) Showerhead

(76) Inventors: Stephen John Cummings, Newport (AU); David George Stone, Baulkham Hills (AU)

(21) Appl. No.: 12/912,302

(22) Filed: Oct. 26, 2010

(30) Foreign Application Priority Data
May 28, 2010 (AU) 2010902360

(51) Int. Cl. B05B 1/00

(52) U.S. Cl. 239/589

(57) ABSTRACT

A showerhead (10) with an outlet defined by an inwardly facing first sharp edge (44) surrounded by an outwardly extending first surface (46). The first surface (46) is angled in the opposite direction to that of water (Sr, Se) leaving the outlet.

### FIELD OF THE INVENTION

The present invention relates to a showerhead.

### BACKGROUND OF THE INVENTION

The perceived level of comfort of a user receiving a spray of water droplets from a showerhead is generally influenced by two factors. The first factor is a uniform coverage or dispersing of water droplets throughout all of the water droplet's spray pattern. In other words, a lack of holes or gaps within the spray pattern where water is not supplied. The second factor is the water impacting the skin at an acceptable force level so as to not generate a stinging sensation.

In recent times, water usage has also become an important factor in the decision of which showerhead to purchase, with a preference emerging for relatively low flow rates (e.g. five to seven litres per minute) in order to conserve water and provide an environmental benefit. To date, many such low flow showerheads do not meet one or both of the comfort factors described above.

In addition, Australian Standard AS/NZS3662 (Performance of Showers for Bathing) require the flow of water leaving a showerhead to have only a small range of variation (two litres per minute) over a wide range of water dynamic flow pressures (150 kPa, 250 kPa and 350 kPa). Some existing low flow showerheads are also unable to satisfy this requirement.

### OBJECT OF THE INVENTION

It is the object of the present invention to provide a showerhead which is able to satisfy the comfort, low flow rate and flow rate variation discussed above.

### SUMMARY OF THE INVENTION

Accordingly, in a first aspect, the present invention provides a showerhead with an outlet defined by an inwardly facing first sharp edge surrounded by an outwardly extending first surface, the first surface angled in the opposite direction to that of water leaving the outlet.

The first sharp edge is preferably machined and polished, as opposed to moulded.

The outlet preferably has a longitudinal axis and the outwardly extending first surface is angled at about 80 to 45 degrees, most preferably 70 degrees, to the axis.

The showerhead preferably includes an inner body assembly and an outer body assembly. The outlet preferably forms part of the inner body assembly.

The outer body assembly preferably also includes an inwardly facing second sharp edge. The second sharp edge is preferably surrounded by an outwardly extending second surface. The second surface is preferably substantially normal to the axis.

The outer body assembly is preferably longitudinally movable relative to the inner body assembly between a retracted position and an extended position. In the retracted position, the second sharp edge is remote from the water leaving the outlet and, in the extended position, the water leaving the outlet is incident upon the second sharp edge.

The showerhead preferably also includes an inlet, most preferably in the form of a swivel joint, and a flow regulator between the inlet and the outlet. The showerhead preferably includes an outlet nozzle adjacent the first sharp edge. The showerhead preferably also includes a relatively small cross sectional area duct between the flow regulator and the outlet nozzle. The showerhead preferably includes a tapered region tapering from a relatively larger cross sectional area adjacent the flow regulator to a relatively smaller cross sectional area adjacent the duct. The showerhead preferably also includes a spray disc between the duct and the outlet nozzle. The showerhead preferably also includes a cylindrical cavity between the duct and the spray disc.

The inlet, the outlet, the flow regulator, the outlet nozzle, the duct, the cavity, the spray disc and the tapered region are preferably in the inner body assembly.

The sharp edge is preferably substantially circular. The outwardly extending surface is preferably frusto-conical.

In a second aspect, the present provides a showerhead including:

an inner body assembly with an inlet at its proximal end and an outlet at its distal end; and

an outer body assembly with an outlet at its distal end;

wherein the outer body assembly is movable relative to the inner body assembly between a first position, where the outlet of the outer body assembly is remote from a flow of water droplets leaving the outlet of the inner body assembly, and a second position where the flow of water droplets leaving the outlet of the inner body assembly is guided into a more concentrated form by the outlet of the outer body assembly.

In a third aspect, the present provides a showerhead including:

an inner body assembly with a proximal end and an outlet at its distal end; and an outer body assembly with an outlet at its distal end, the outer body assembly

longitudinally movable relative to the inner body assembly between a retracted position and an extended position, wherein, in use, a flow of water droplets leaving the outlet of the inner body assembly do not contact the outlet of the outer body assembly in the retracted position and do contact and are concentrated by said contact in the extended position.

The outlet of the inner body assembly is preferably defined by an inwardly facing first sharp edge surrounded by an outwardly extending first surface, the first surface angled in the opposite direction to that of the flow of water droplets leaving the outlet.

The first sharp edge is preferably machined and polished, as opposed to moulded.

The outlet of the inner body assembly preferably has a longitudinal axis and the outwardly extending first surface is angled at about 80 to 45 degrees, most preferably 70 degrees, to the axis.

The outlet of the outer body assembly preferably also includes an inwardly facing second sharp edge. The second sharp edge is preferably surrounded by an outwardly extending second surface. The second surface is preferably substantially normal to the axis.

The showerhead preferably also includes an inlet, most preferably in the form of a swivel joint, and a flow regulator between the inlet and the outlet. The showerhead preferably includes an outlet nozzle adjacent the first sharp edge. The showerhead preferably also includes a relatively small cross sectional area duct between the flow regulator and the outlet nozzle. The showerhead preferably includes a tapered region tapering from a relatively larger cross sectional area adjacent the flow regulator to a relatively smaller cross sectional area adjacent the duct. The showerhead preferably also includes a spray disc between the duct and the outlet nozzle. The showerhead preferably also includes a cylindrical cavity between the duct and the spray disc.

The inlet, the outlet, the flow regulator, the outlet nozzle, the duct, the tapered region, the cavity and the spray disc are preferably in the inner body assembly.

The sharp edge is preferably substantially circular. The outwardly extending surface is preferably frusto-conical.

In a fourth aspect, the present invention provides a showerhead including: an inlet, an outlet and a central bore therebetween;

a spray disc mounted in a fixed position in the bore between the inlet and outlet so as to not move relative to the inlet or outlet in response to a flow of water therethrough.

The bore preferably includes a shoulder against which the spray disc locates. The bore preferably includes a narrow duct, upstream of the spray disc, and a substantially cylindrical cavity of fixed axial dimension between the duct and the spray disc.

The spray disc is preferably in the form of a disc with a plurality of holes therein, most preferably a series of equi-angularly spaced holes near the perimeter of the disc.

The showerhead preferably comprises an inner body assembly, including an inlet part including the inlet and an outlet part including the outlet and a flow regulator is preferably sandwiched between the inlet part and the outlet part. The outlet part preferably includes the shoulder.

The showerhead preferably also includes an outer body assembly that is longitudinally moveable relative to the inner body assembly between a retracted position and an extended position.

### BRIEF DESCRIPTION OF THE DRAWINGS

A preferred embodiment of the present invention will now be described, by way of an example only, with reference to the accompanying drawings wherein:

FIG. 1 is a front exploded perspective view of an embodiment of a showerhead;

FIG. 2 is a rear exploded perspective view of the showerhead shown in FIG. 1;

FIG. 3 is a cross-sectional side view of the showerhead shown in FIG. 1 in a retracted configuration;

FIG. 4 is a front perspective view of the showerhead shown in FIG. 1 in the retracted configuration;

FIG. 5 is a rear perspective view of the showerhead shown in FIG. 1 in the retracted configuration;

FIG. 6 is a cross-sectional side view of the showerhead shown in FIG. 1 in an extended configuration;

FIG. 7 is a front perspective view of the showerhead shown in FIG. 1 in the extended configuration; and

FIG. 8 is a rear perspective view of the showerhead shown in FIG. 1 in the extended configuration.

### DETAILED DESCRIPTION OF THE PREFERRED EMBODIMENT

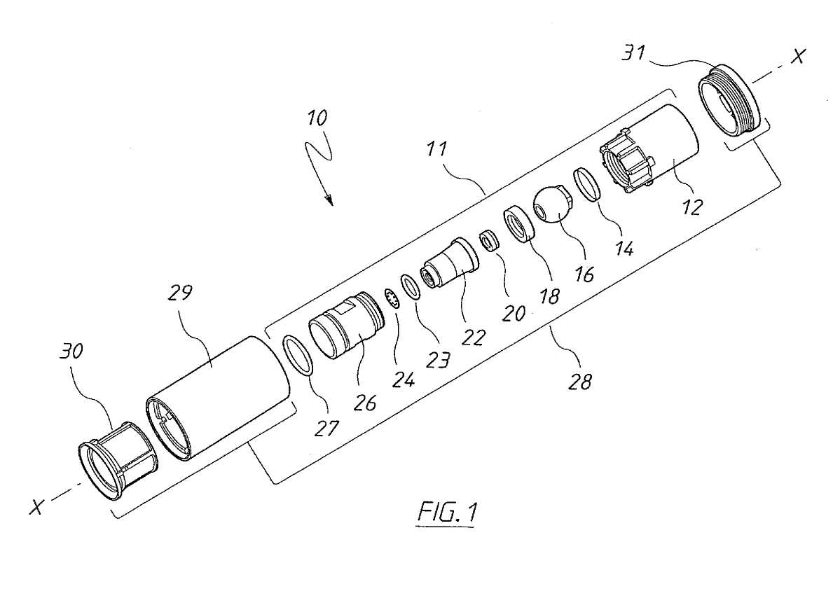

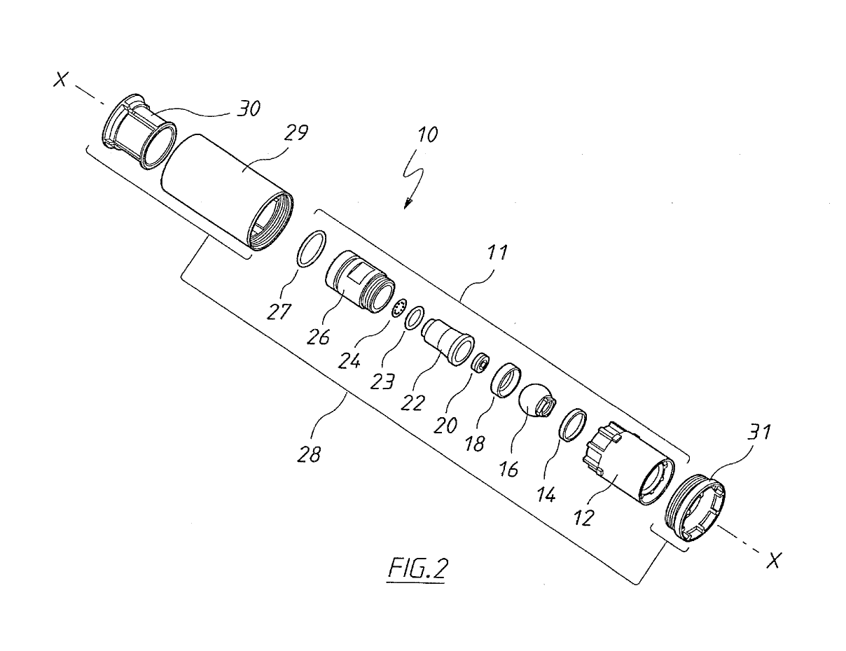

FIGS. 1 and 2 show front and rear exploded views respectively of an embodiment of a showerhead 10, with a longitudinal axis X-X.

The showerhead 10 includes an inner body assembly 11 comprising: a plastic retainer housing 12; a plastic retaining ring 14; a chrome plated brass swivel ball 16; a rubber swivel joint seal 18; a flow regulator 20; a plastic regulator housing 22; a first O-ring 23; a stainless steel, brass or aluminium spray disc 24; a plastic, brass or aluminium nozzle 26; and a second O-ring 27.

The showerhead 10 also includes an outer body assembly 28 comprising: a plastic outer housing part 29; a plastic inner housing part 30 and a plastic retaining nut 31.

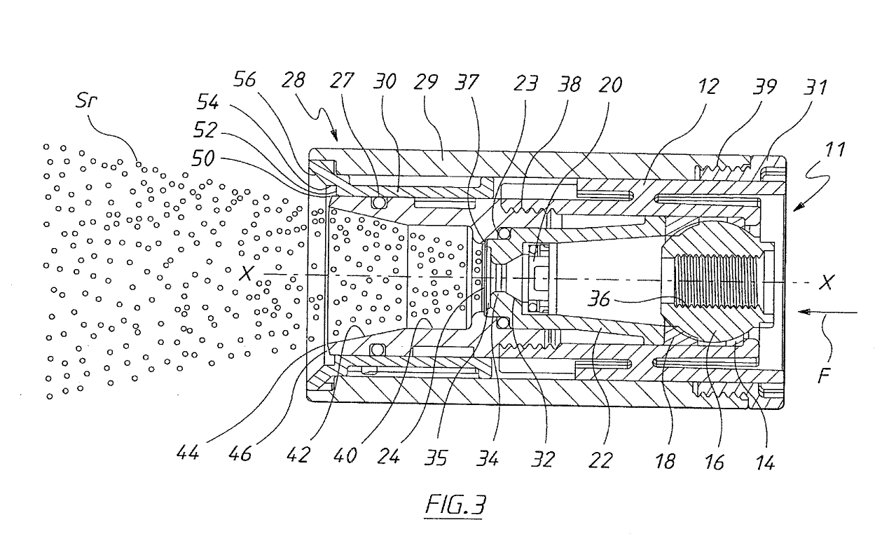

As best shown in FIG. 3, the flow regulator 20 is a pressure compensating type marketed by Neoperl. The flow regulator 20 is produced from two plastic moulded components consisting of an outer body and an inner body with a waterway cavity therebetween. An O-ring is seated internally around the waterway cavity between the outer body and the inner body. The O-ring deforms in response to pressure through the flow regulator 20 to alter the size of the cavity and thus regulates the flow rate. The flow regulator 20 is pressed into the interior of the regulator housing 22. The function of the flow regulator 20 is well understood by persons skilled in the art.

Downstream of the flow regulator 20, the regulator housing 22 includes a tapered region 32 which tapers, from an internal diameter of approximately 9.2 mm to 5.0 mm, into a relatively narrow duct 34 with an internal diameter of approximately 5.0 mm. Downstream of the duct 34 is a cylindrical circular cavity 35 approximately 12.0 mm diameter and approximately 0.80 mm to 1.50 mm long. The edge between the duct 34 and the cavity 35 has a 1.0 mm radius. The spray disc 24 is positioned downstream of the cavity 35 and is sandwiched between the housing 22 and the nozzle 26 and located against shoulder 39. As a result, the spray disc 24 is unable to move relative the housing 22 or the cavity 35 in response to changes in water pressure.

The spray disc 24 is approximately 14.9 mm in diameter and includes 10 equi-angularly spaced holes of approximately 1.1 mm in diameter on a pitch circle diameter of approximately 9.6 mm.

The swivel ball 16 is positioned upstream of the flow regulator 20 and has a bore 36 therethrough. The bore 36 is adapted for connecting to a source of water and thereby forms the inlet of the showerhead 10. The swivel ball 16 also defines the proximal end of the showerhead 10.

The swivel ball 16, the swivel joint seal 18 and the retaining ring 14 are located by the retainer housing 12 screwing into engagement with the nozzle 26 at threads 38, thereby forming the inner body assembly 11. In this way, the regulator housing 22 is fixed between the nozzle 26 and the swivel ball 16. The connection between the regulator housing 22 and the nozzle 26 is sealed by the first O-ring 23.

The outer body assembly 28 is formed by the outer housing part 29 snap-engaging with the inner housing part 30 and the retaining nut 31 screwing into engagement with the outer housing part 30 at threads 39.

Downstream of the spray disc 24, the nozzle 26 has a cylindrical wall 40 followed by an outwardly tapering wall 42. The tapered wall part 42 has a highly polished surface finish. The tapered part 42 terminates in an inwardly facing first sharp edge 44. The nozzle 26 also includes a first surface 46 angled away from the sharp edge 44 in the opposite direction to that of water droplets leaving the showerhead 10. The first surface 46 is a machined/polished frusto-conical surface angled at approximately 70° to the axis X-X. The first sharp edge 44 and the first angled surface 46 define the proximal end of the showerhead 10.

The inner housing part 30 of the outer body assembly 28 terminates in a second inwardly facing sharp edge 50. The inner housing part 30 also includes an outwardly extending second surface 52 adjacent the second sharp edge 50. The second surface 52 is angled at approximately 70° to the longitudinal axis X-X. As with the first sharp edge 44 and the first angled surface 46, the second sharp edge 50 and the second angled surface 52 are both produced by machining and polishing. A longitudinal wall part 54 is positioned distally of the second angled surface 52 and leads to a further frusto-conical surface 56.

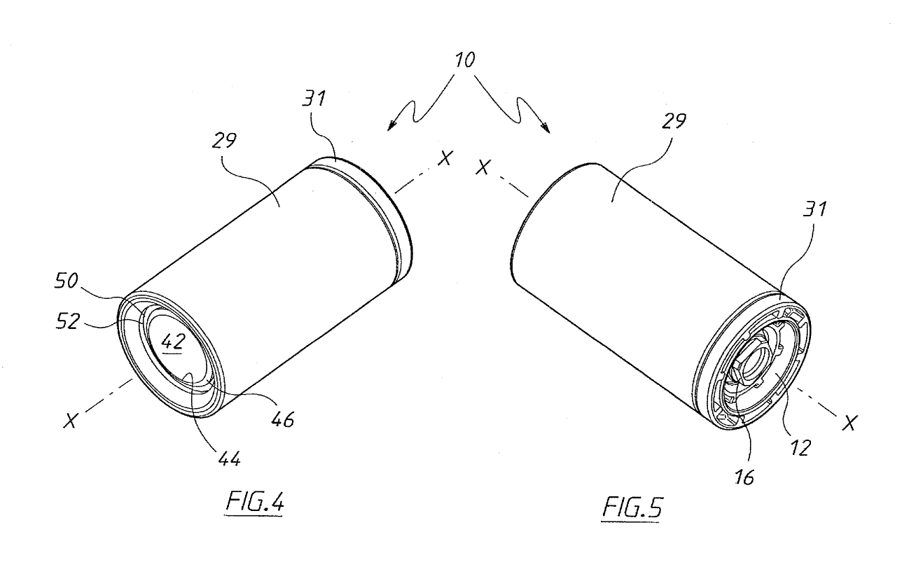

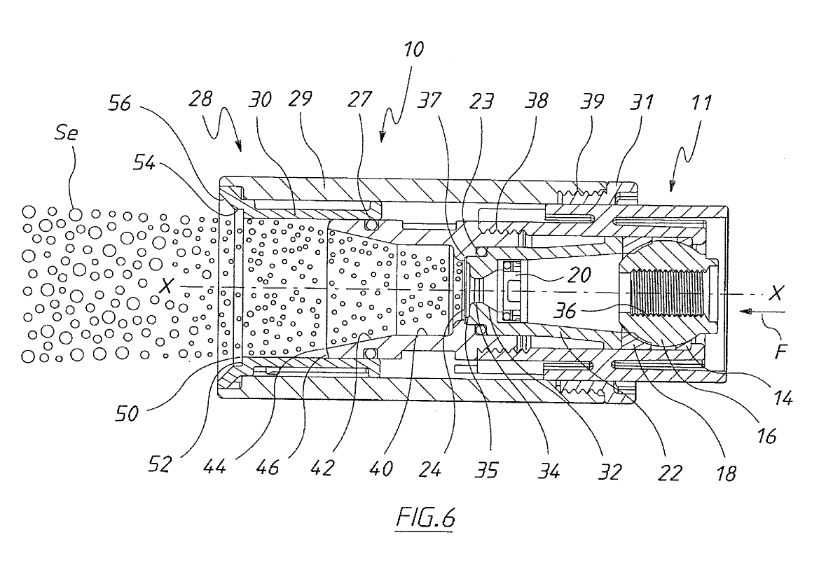

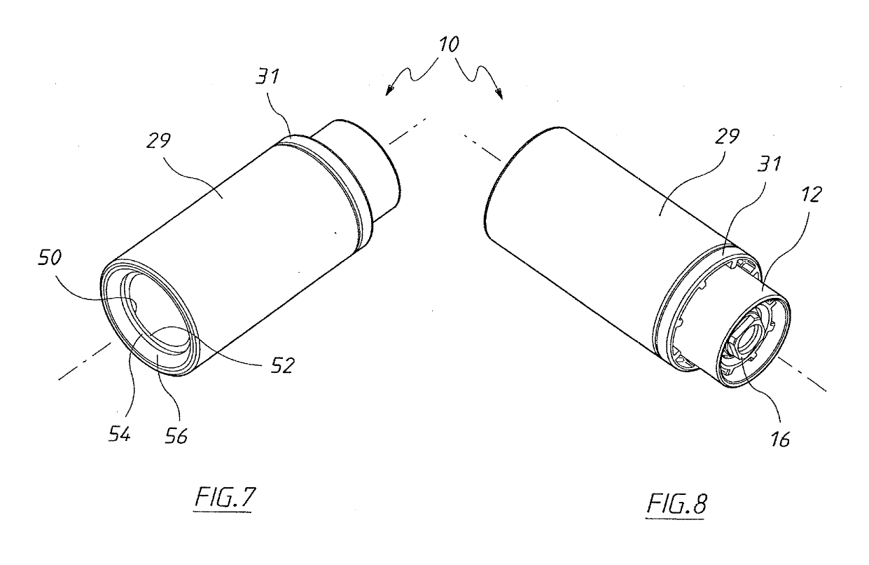

As best seen in FIG. 6, the outer body assembly 28 is longitudinally slidable relative to the inner body assembly 11. The relative positioning shown in FIGS. 3, 4 and 5 is a first or retracted configuration. The relative positioning shown in FIGS. 6, 7 and 8 is a second or extended configuration. The frictional fit of the second O-ring 27 between the nozzle 26 and the inner sleeve 48 ensures the inner body assembly 11 and the outer body assembly 28 can be manually moved between the two configurations and will thereafter remain in the desired configuration until moved again.

In use, water is supplied in the direction of flow F which passes: through the bore 36 of the swivel ball 16; through the interior of the regulator housing 22; through the regulator 20; and through the tapered part 32 into the duct 34; and into the cylindrical cavity 35. The water is then forced through the holes in the spray disc 24.

When the showerhead 10 is in the retracted position, the water droplets pass through the cylindrical part 40 and the tapered part 42 and exit the showerhead at the first sharp edge 44 generally in the spray pattern Sr indicated on FIG. 3. Tests conducted by the Applicant have found that the sharp edge 44 avoids the formation of droplets within the showerhead 10 and results in all water supplied to the showerhead 10 exiting the showerhead as the spray pattern Sr of water droplets. This is an advantage as droplets generated in a showerhead eventually lead to drips falling from the showerhead, which is perceived as a sign of poor quality by users.

FIG. 6 shows the showerhead in the extended configuration in which the water droplets leaving the first sharp edge 44 are incident upon the second sharp edge 50 before leaving the showerhead 10. As a result, the water droplets leaving the showerhead 10 are guided into a more concentrated form, as shown by the spray pattern Se in FIG. 6. being narrower than the spray pattern Sr in FIG. 3. This narrower or more concentrated spray pattern Se is particularly advantageous in situations requiring larger size water droplets producing a more dense flow of water across a smaller surface area, for example when rinsing shampoo from hair.

Further, the transitioning of the water flow through the flow regulator 20, the tapered part 32, the duct 34 and into the cylindrical cavity 35 before reaching the holes in the spray disc 24 advantageously results in a very uniform dispersion of water droplets within the spray pattern (i.e. no holes or gaps), together with an acceptable force on the skin of the user. The Applicant believes that this uniformity is at least partially due to the spray disc 24 being unable to move relative the housing 22 or the cavity 35.

In addition, tests conducted by the Applicant at water dynamic flow pressures of 150 kPa, 250 kPa and 350 kPa yielded flow rates from the showerhead 10 of 5.6, 6.9 and 6.8 litres per minute respectively. Advantageously, this is a relatively constant output and well within the maximum two litres per minute variation allowed by current the performance requirements of Australian Standard AS/NZS3662 (Performance of Showers for Bathing) for lower flow showerheads.

Although the invention has been described with reference to a preferred embodiment, it will be appreciated by persons skilled in the art that the invention may be embodied in many other forms.

What is claimed is:

1. A showerhead with an outlet defined by an inwardly facing first sharp edge surrounded by an outwardly extending first surface, the first surface angled in the opposite direction to that of water leaving the outlet.

2. The showerhead as claimed in claim 1, wherein the outlet has a longitudinal axis and the outwardly extending first surface is angled at about 80 to 45 degrees to the axis.

3. The showerhead as claimed in claim 2, wherein the outlet has a longitudinal axis and the outwardly extending first surface is angled at about 70 degrees to the axis.

4. The showerhead as claimed in claim 1, wherein the showerhead includes an inner body assembly and an outer body assembly.

5. The showerhead as claimed in claim 4, wherein the outer body assembly also includes an inwardly facing second sharp edge.

6. The showerhead as claimed in claim 5, wherein the second sharp edge is surrounded by an outwardly extending second surface.

7. The showerhead as claimed in claim 6, wherein the second surface is substantially normal to the axis.

8. The showerhead as claimed in claim 4, wherein the outer body assembly is longitudinally movable relative to the inner body assembly between a retracted position and an extended position, wherein, in the retracted position, the second sharp edge is remote from the water leaving the outlet and, in the extended position, the water leaving the outlet is incident upon the second sharp edge.

9. A showerhead including:
an inner body assembly with a proximal end and an outlet at its distal end; and
an outer body assembly with an outlet at its distal end, the outer body assembly longitudinally movable relative to the inner body assembly between a retracted position and an extended position, wherein, in use, a flow of water droplets leaving the outlet of the inner body assembly do not contact the outlet of the outer body assembly in the retracted position and do contact and are concentrated by said contact in the extended position.

10. The showerhead as claimed in claim 9, wherein the outlet of the inner body assembly is defined by an inwardly facing first sharp edge surrounded by an outwardly extending first surface, the first surface angled in the opposite direction to that of the flow of water droplets leaving the outlet.

11. The showerhead as claimed in claim 9, wherein the outlet of the inner body assembly has a longitudinal axis and the outwardly extending first surface is angled at about 80 to 45 degrees to the axis.

12. The showerhead as claimed in claim 11, wherein the outwardly extending first surface is angled at about 70 degrees to the axis.

13. The showerhead as claimed in claim 10, wherein the outlet of the outer body assembly also includes an inwardly facing second sharp edge.

14. The showerhead as claimed in claim 13, wherein the second sharp edge is surrounded by an outwardly extending second surface.

15. The showerhead as claimed in claim 14, wherein the second surface is substantially normal to the axis.

16. A showerhead including:
an inlet, an outlet and a central bore therebetween;
a spray disc mounted in a fixed position in the bore between the inlet and outlet so as to not move relative to the inlet or outlet in response to a flow of water therethrough.

17. The showerhead as claimed in claim 16, wherein the bore includes a shoulder against which the spray disc locates.

18. The showerhead as claimed in claim 17, wherein the bore includes a narrow duct, upstream of the spray disc, and a substantially cylindrical cavity of fixed axial dimension between the duct and the spray disc.

19. The showerhead as claimed in claim 16, wherein the showerhead comprises an inner body assembly, including an inlet part including the inlet and an outlet part including the outlet and a flow regulator is sandwiched between the inlet part and the outlet part.

20. The showerhead as claimed in claim 19, wherein the showerhead also includes an outer body assembly that is longitudinally moveable relative to the inner body assembly between a retracted position and an extended position.
